(19) United States
(12) Patent Application Publication
(10) Pub. No.: US 2003/0180182 A1
(43) Pub. Date: Sep. 25, 2003

(54) Dry analytical element that avoids influence of globulin

(76) Inventors: Hitomi Saito, Asaka-shi (JP); Kazuya Kawasaki, Asaka-shi (JP); Osamu Seshimoto, Asaka-shi (JP)

Correspondence Address: BIRCH STEWART KOLASCH & BIRCH, PO BOX 747, FALLS CHURCH, VA, 22040-0747, US

(21) Appl. No.: 10/359,131

(22) Filed: Feb. 6, 2003

(30) Foreign Application Priority Data
Feb. 7, 2002 (JP) 2002-030401

(51) Int. Cl. G01N 31/22

(52) U.S. Cl. 422/56

(57) ABSTRACT

The present invention provides a dry analytical element comprising, on a support, a layer containing a reagent capable of precipitating globulin. The present invention can provide a dry analytical element which cal overcome the drawback that the viscosity of a sample varies depending on the globulin concentration and the developing area of the sample varies, and can also avoid an error caused by the reaction between the reagent which changes color upon reaction with albumin, and globulin in the sample.

### TECHNICAL FIELD

The present invention relates to a dry analytical element which can avoid an influence of globulin existing in a sample. The dry analytical element according to the present invention is useful in the field of clinical tests such as the analysis of albumin.

### BACKGROUND ART

Many types of single-unit multilayer analytical elements have been proposed as embodiments of a conventional dry analytical element. These elements comprise, on a transparent support, a water-absorptive reagent layer comprising a coloring reaction reagent and a hydrophilic polymer binder, and a porous developing layer as an outmost layer. The developing layer in the multilayer analytical element has a mete action which spreads, in a lateral direction an aqueous liquid sample (e.g., biological fluids such as blood, spinal fluid, saliva, lymph, and urine; drinking water, alcohols; steam water; and industrial waste water) which is spotted on the upper surface (the surface on the side farthest from the support) without substantially allowing the irregular distribution of components contained in the aqueous liquid samples, thereby supplying the sample to the reagent layer comprising a water-absorptive hydrophilic polymer or the water-absorbing layer at a substantially constant volume per unit area.

When a globulin-containing sample is applied to such a dry analytical element viscosity of the sample varies depending on the globulin concentration in the sample. As a result there is a problem that the developing area of the sample varies. More specifically, when the globulin concentration in the sample varies, the developing area also varies, thereby king it impossible to obtain accurate measured values.

As a method for measuring or quantifying albumin in biological fluids (e.g., blood, spinal fluid, saliva, lymph, and urine), some methods are known wherein a buffered bromocresol green (BCG) solution or a test piece described in, for example, U.S. Pat. No. 3,533,749 and U.S. Pat. No. 3,485,587, is used. BCG is one type of acid-base indicator dyes belonging to sulfonphthalein dyes which change color upon binding to a protein. BCG changes its color depending on the amount of protein (e.g. albumin) existing in the aqueous liquid.

Acid-base indicators such as BCG are not specific to albumin. Globulin, transferrin and other proteins existing in human body fluids compete with albumin to bind to an acid-base indicator dye, inhibit the analysis of albumin, and cause an error in the measured value. This competitive inhibition is particularly significant with regard to a low concentration level of albumin. The total protein concentration in normal human serum is about 6 to 8 g/dl, and about 2.5 to 3.5 g/dL thereof is globulin and the remainder is albumin. The total protein concentration in abnormal human serum is sometimes about 2 to 6 or about 8 to 12 g/dL. In the case of hyperglobulinemia and the like, the concentration of globulin may be 10 g/dL or higher.

JP Patent Publication (Unexamined Application) No. 57-50660 (ASP No. 4,333,733) discloses a dry single-unit multilayer analytical element. This element comprises a reagent layer (reagent zone) having BCG and a buffer dispersed in a nonprotein binder polymer and a porous developing layer (reaction layer; reaction zone), both of which layers are adhesively laminated in that order on a transparent support, and this element has a lowered competitive inhibition. When human serum is spotted on the developing layer of this element, moisture is supplied from the developing layer to the reagent layer and both layers are wetted and in contact with each other, and then BCC diffuses and migrates from the reagent layer into the developing layer, preferentially binds to albumin and develops a color which is characteristic of the BCG-albumin bond. Thus, this element is a type of dry-operative wherein the albumin content is determined by assaying the color density after change of color based on the principle of colorimetry. Even with the use of this element, however, when the measurement time is prolonged (about 3 to 7 minutes), a measurement error caused by competitive inhibition by inhibiting components such as globulin was found to be considerable.

JP Patent Publication (Unexamined Application) No. 61-243364 and JP Patent Publication (Unexamined Application) No. 62-137564 disclose a dry single-unit multilayer analytical element for quantifying albumin. This element has an adhesive laminate comprising, on a transparent support, a pH buffer-containing nonprotein hydrophilic polymer binder layer (pH buffer-containing water-absorbing layer) and a porous developing layer (a reagent developing layer) having indicators such as BCG impregnated therein, and this element has a lowered competitive inhibition by globulin.

JP Patent Publication (Unexamined Application) No. 62-27664 discloses an improved type of the element mentioned above. This element comprises diaboxylic acids such as glutaric acid, adipic acid, pimelic acid or a derivative thereof as pH buffers for the pH buffer-containing water-absorbing layer. However, the competitive inhibition by globulin still appeared in these multilayer analytical elements

Further, JP Patent Publication (Unexamined Application) No. 62-24150 discloses a dry single-unit multilayer analytical element for quantifying albumin. This element has a adhesive laminate comprising, on a transparent support a pH buffer-containing nonprotein hydrophilic polymer binder layer (pH buffer-containing water-absorbing layer) and a fibrous porous developing layer (reagent developing layer) having indicators such as BCG immobilized with a reactive polymer and the like, and his element has a lowered competitive interference by globulin. In this multilayer analytical element, indicators are immobilized by a reactive polymer and the like, and the reaction speed for discoloration is slow. Thus, a drawback such as low sensitivity was found.

Furthermore, JP Patent Publication (Examined Application) No. 6-68494 discloses a single-unit multilayer analytical element for quantifying albumin. This element comprises at least one hydrophilic polymer binder layer and a porous developing layer comprising indicators integrally laminated in this order on a light-transmissive water-impermeable support, wherein the developing layer comprises an indicator which is dispersed in a hydrophilic polymer or a mixture of a hydrophilic polymer and a hydrophobic polymer and changes color upon binding to albumin, and a pH buffer composition. Even with the use of this single-unit multilayer analytical element for analyzing albumin, however, an influence of globulin appears when the sample is obtained from a subject with hyperglobulinemia

### SUMMARY OF THE INVENTION

An object of the present invention is to overcome the problems in the prior art as mentioned above. More specifically, an object of the present invention is to provide a dry analytical element which overcomes a drawback that the viscosity of a sample varies depending on the globulin concentration and the developing area of the sample varies. Further, another object of the present invention is to provide a dry analytical element which can avoid an error caused by the reaction between a reagent which changes color upon reaction with albumin and globulin the sample.

The present inventors have conducted concentrated studies in order to attain the above objects. Specifically, they assayed a globulin-containing sample using a dry analytical element which comprises, on a support, a layer containing a reagent capable of precipitating globulin. As a result, they have found that an excellent dry analytical element capable of solving the above objects can be obtained, thereby completing the present invention.

Thus, the present invention provides a dry analytical element comprising, on a support, a layer containing a reagent capable of precipitating globulin.

Preferably, the reagent capable of precipitating globulin is sodium sulfate, sodium sulfite, or ammonium sulfate.

Preferably, the dry analytical element according to the present invention is used to detect albumin.

Preferably, the dry analytical element according to the present invention comprises, on a support, a layer containing a reagent which changes color upon binding with albumin and a layer containing a reagent capable of precipitating globulin.

Preferably, the dry analytical element according to the present invention comprises at least a layer containing a reagent which develops color upon reaction with albumin and a layer containing a reagent capable of precipitating globulin, both layers of which are integrally laminated in that order on a light-transmissive water-impermeable support.

### PREFERRED EMBODIMENT FOR CARRYING OUT THE INVENTION

The embodiments and processes for carrying out the present invention are hereinafter described in detail.

The dry analytical element according to the present invention is characterized by comprising, on a support, a layer containing a reagent capable of precipitating globulin.

A reagent capable of precipitating globulin is not particularly limited, and examples of a usable reagent include sodium sulfate, sodium sulfite, and ammonium sulfate. These reagents can be used solely or in combination of two or more.

The amount of the reagent capable of precipitating globulin to be used can be suitably determined by taking the type of reagent used, the assay conditions and the like into consideration. The amount is generally 0.1 to 30 g/m², and preferably about 0.5 to 10 g/m².

The dry analytical element according to the present invention can be used without any particular limitation, and can be used for analyzing various components. The dry analytical element according to the present invention can take various forms depending on the assay purpose, and generally comprises a support and one or more layers coated thereon. In the present invention, at least one layer coated on the support comprises a reagent capable of precipitating globulin.

Examples of the layers to be coated on the support include:

(1) a water-absorbing layer mainly composed of a hydrophilic polymer that swells upon absorption of water,

(2) a reagent layer comprising a detection reagent which reacts or binds with a component to be detected, thereby detecting or quantifying the component; and

(3) a developing layer having a metering action that spreads, in a lateral direction, an aqueous liquid sample which is spotted on the upper surface of the dry analytical element without substantially allowing the irregular distribution of components existing in the aqueous liquid sample, thereby supplying the sample to the reagent layer comprising a water-absorptive hydrophilic polymer or the water-absorbing layer at a substantially constant volume per unit area.

An intermediate layer, such as an adhesive layer, can be provided between a support and a layer superposed thereon and between layers provided on the support.

The dry analytical element according to e present invention does not necessarily comprise all the layers mentioned above, aid a necessary layer can be suitably provided depending on the applications and purposes of the detection and assay.

The water-absorbing layer, the reagent layer and the developing layer can be separately provided. Alternatively, two or more of the above-mentioned functions can be simultaneously imparted to the same layer to provide them as one layer. For example, a reagent layer containing a detection reagent and a developing layer having a metering action can be provided as one layer.

The reagent capable of precipitating globulin that is used in the present invention can be coated as a layer which is provided separately from the water-absorbing layer, the reagent layer and the developing layer. Alternatively, the reagent can be coated by being incorporated into at least one of the water-absorbing layer the agent layer, and the developing layer. Preferably, the reagent capable of precipitating globulin can be contained in the reagent layer or the developing layer, and particularly preferably in the developing layer.

According to a preferred embodiment, the dry analytical element of the present invention is a single-unit multilayer analytical element which comprises a laminate having a water-absorbing layer containing a reagent and a developing layer containing a reagent capable of precipitating globulin in that order from the support side.

According to a more preferred embodiment the dry analytical element of the present invention is a single-unit multilayer analytical element which comprises a water-absorbing layer and a developing layer containing a reagent, and wherein a reagent capable of precipitating globulin is contained in an upper portion of a developing layer.

The components that can be present in the dry analytical element of the present invention are hereinafter described.

The support used in the present invention is preferably a light-transmissive water-impermeable support. A known support which is used in conventional single-unit multilayer analytical elements can be used as the light-transmissive water-impermeable support. Specific examples of the support that can be used include a support composed of a polymer such as polyethylene terephthalate, polycarbonate of bisphenol A, polystyrene, or cellulose ester (e.g., cellulose diacetate, cellulose triacetate, and cellulose acetate propionate), which has a thickness of about 50 μm to about 1 mm, preferably about 80 μm to about 300 μm, and which is transparent (e.g., which allows transmission of electromagnetic radiation of at least one part of a wavelength range within a range of about 200 nm to about 900 nm), smooth and flat. A known undercoat or adhesive layer can be provided on the surface of the support to strengthen the adhesion with the water-absorbing layer.

The water-absorbing layer is mainly composed of a hydrophilic polymer binder that can swell upon contact with water and can absorb water. When water in an aqueous liquid sample spotted on the developing layer during the analyzing operation reaches the upper surface of the water-absorbing layer, the water-absorbing layer can facilitate the developing of the aqueous liquid sample on the developing layer.

A polymer binder used for the water-absorbing layer is a nonprotein hydrophilic polymer which swells upon contact with water and absorb water. Examples of a nonprotein hydrophilic polymer include: an acrylamide copolymer such as polyacrylamide, agaose, an acrylamide-N-vinyl pyrrolidone copolymer described in, for example, JP Patent Publication (Unexamined Application) No. 57-50660 and JP Patent Publication (Unexamined Application) No. 58-77664, a methallyl alcohol copolymer such as a binary or ternary copolymer of methallyl alcohol and acrylamide or its derivative, acrylic acid or its derivative, methacrylic acid or its derivative, or N-vinyl-2-pyrrolidone as described in JP Patent Publication (Unexamined Application) No. 62-137564 (a methallyl alcohol copolymer is crosslinkable and curable, e.g., a ternary copolymer of acrylamide-N-vinyl-2-pyrrolidone-methallyl alcohol).

Among these nonprotein hydrophilic polymers, an acrylamide copolymer such as an acrylamide-N-vinyl pyrrolidone copolymer and a methallyl alcohol-containing copolymer such as a ternary copolymer of acrylamide-N-vinyl-2-pyrrolidone-methallyl alcohol are preferable.

The coating amount of a polymer binder used in the water-absorbing layer is about 5 g to 100 g/m², and preferably about 7 to 70 g/m². A polymer binder can be used in combination of two or more, if necessary.

The water-absorbing layer can comprise various types of components that do not adversely affect the capacity of a detection reagent (e.g., an indicator) which binds to the analyte. Examples thereof include a nonionic surfactant. Specific examples of a nonionic surfactant include those similar to surfactants that can be contained in the reagent layer or Fe developing layer described below. Incorporation of a nonionic surfactant into the water-absorbing layer facilitates the substantially uniform absorption of water in the aqueous liquid sample onto the water-absorbing layer during the analyzing operation, and also allows rapid and substantially uniform liquid contact with the reagent-developing layer. The water-absorbing layer can also contain a buffer described below.

The water-absorbing layer can contain a crosslinking agent (this may be referred to as a curing agent or hardening agent). Various inorganic and organic crosslinking agents which are known in the field of organic polymer chemistry can be used as the crosslinking agent. Examples of organic crosslinking agents for polyvinyl alcohol include dimethylurea, and examples of organic crosslinking agents for methallyl alcohol-containing polymers include formaldehyde. The content of the crosslinking agent in the water-absorbing layer can be selected depending on the coating amount and the level of hardening of the water-absorbing layer to be crosslinked or cured. In general, the coating amount is in the range of about 50 mg/m² to about 5,000 mg/m², and preferably about 100 mg/m² to about 2,000 mg/m².

If necessary, two or more water-absorbing layers can be provided. When two or more water-absorbing layers are provided, a high molecular weight pH buffer or high molecular weight acid call be contained in the layer which is close to the reagent-developing layer. Examples of a usable high molecular weight acid include a known carboxyl group-containing polymer and sulfonic acid group-containing polymer. When two water-absorbing layers are provided, the nonprotein hydrophilic polymer as well as various hydrophilic polymers can be used in the water-absorbing layer which is close to the support. Examples of such hydrophilic polymers include deionized gelatin.

The thickness of the water-absorbing layer on a dry basis is generally about 1 μm to about 100 μm, and preferably about 3 μm to about 50 μm.

The reagent layer comprises a detection reagent which reacts or binds with a component to be detected so as to allow the component to be detected or quantified. The reagent layer is preferably water-absorptive or water-permeable. Preferable examples of the reagent layer include a layer which is substantially nonporous and water-absorptive and a layer which is microporous and water permeable, which comprise at least one reagent which can generate a detectable change by reacting with the analyte in the liquid sample and a hydrophilic polymer binder. A detectable change mainly refers to a change that can be detected by optical measurements, and examples thereof include color change, color development (coloration), fluorescence development, change in the absorption wavelength in the ultraviolet region, and opacification.

The reagent contained in the reagent layer is determined depending on the type of the component to be analyzed in the liquid sample and the chemical reaction selected for analyzing the component. When two or more reagents are involved in the selected chemical reaction, these reagents can be nixed and contained in one reagent layer. Alternatively, two or more reagents can be contained in two or more separate layers. The reagents to be contained in the reagent layer include various enzymes, other known analytical reagents, or reagents for clinical biochemical diagnoses.

According to a preferred embodiment the dry analytical element of the present invention is used for detecting albumin. Specifically, one embodiment of the present invention provides a dry analytical element which comprises, on a support a layer containing a reagent which changes color upon binding to albumin, and a layer containing a reagent which is capable of precipitating globulin.

Preferably, an acid-base indicator dye, which indicates a protein error as described in, for example, I. M. Kolthoff, “Acid-Base Indicators” (MacMillan, 1937, pp 350-353), is used as a reagent which changes color upon binding to albumin. Examples of acid-base indicator dyes indicating a protein error include: sulfonphthalein indicator dyes such as bromocresol green, bromocresol purple, bromothymol blue, bromphenol blue, chlorophenol red, phenol red, cresol red, thymol blue, and cresolphthalein; indigoid dyes such as indigocarmine; and azo dye indicators such as Methyl Red and Methyl Orange. Among these indicators, a sulfonphthalein indicator dye is preferred, with bromocresol green (BCG) and bromocresol purple (BCP) being the most preferred.

The amount of an acid-base indictor dye contained in the reagent layer is about 0.2 to 3.0 g/m², and preferably about 0.4 to 1.5 g/m².

Examples of usable developing layers include: a woven developing layer (e.g., plain weave such as broad and poplin) described in, for example, JP Patent Publication (Unexamined Application) No. 55-164356 and JP Patent Publication (Unexamined Application) No. 57-66359; a knitted developing layer (e.g., tricot stitch, double tricot stitch, and milanese stitch) described in, for example, JP Patent Publication (Unexamined Application) No. 60-222769; a developing layer composed of a paper containing fibrous pulp of an organic polymer described in JP Patent Publication (Unexamined Application) No. 57-148250; a nonfibrous isotopically porous developing layer such as a intercommunicating microspace-containing porous layer comprising a membrane filter (a blush polymer layer), polymer microbeads, glass microbeads, and diatomaceous earth retained by a hydrophilic polymer binder described in, for example, JP Patent Publication (Examined Application) No 53-21677 and the U.S. Pat. No. 3,992,158; and a nonfibrous isotopically porous developing layer comprising an intercommunicating microspace-containing porous layer (a layer of three-dimensional lattice particulate construct) wherein polymer microbeads are adhered in the state of spot contact with the aid of a polymer adhesive which is not swollen with water, as described in JP Patent Publication (Unexamined Application) No. 55-90859. In the case of a reagent layer; a fibrous developing layer such as a woven developing layer and a knitted developing layer is preferred from the viewpoint of easy retention of a hydrophilic polymer for holding a reagent such as an indicator in a dispersed state.

A preferred hydrophilic polymer for holding the detection reagent (indicator) in a dispersed state is one that is gradually dissolved or swollen in water in the liquid sample when the aqueous liquid sample is spotted on the developing layer and that is capable of holding the indicator in a dispersed state without substantially reacting with the indicator nor substantially immobilizing the indicator. It is preferred to hold the indicator in the developing layer in a dispersed state with the indicator being dispersed in the hydrophilic polymer.

A hydrophilic polymer can be suitably selected from known hydrophilic or hydrophobic polymers described in, for example, “Koubunshi Zairyou Binran (Handbook on polymeric materials),” (the Society of Polymer Science, Japan (ed.), CORONA PUBLISHING CO., LTD., 1973), “Kagaku Daijiten (Unabridged Dictionary of Chemistry),” (KYORITSU SHUPPAN CO., LTD. 1960-1963), “Suiyousei Koubunshi (Water Soluble Polymer),” (Ekio Nakamura (ed.), Kagaku Kougyousha, 1973), “Water-Soluble Resins, 2nd Ed,” (R. L. Davidson, M. Sittig (ed.), REINHOLD BOOK CORP., 1968), and “Polymer Handbook,” (J. Brandrup, E. H. Immergut (ed.), INERSCIENCE PUBLISHERS, 1966).

Examples of a hydrophilic polymer that can be used herein include: a hydrophilic cellulose derivative polymer; a hydrophilic vinyl polymer or copolymer, and a hydrophilic acrylate ester polymer or copolymer. The use of a mixture of a hydrophilic polymer and a hydrophobic polymer imparts an advantage such that the release rate from the polymer of the indicator which changes color upon binding with albumin can be controlled in a desired wide range.

Examples of a hydrophilic cellulose derivative polymer include a hydrophilic or water soluble cellulose derivative described in, for example, Suiyousei Koubunshi (Water Soluble Polymer),” (Ekio Nakamura (ed.), Kagaku Kougyousha, 1973), “Water-Soluble Resins, 2nd Ed.,” (R. L. Davidson, M. Sittig (ed.), REINHOLD BOOK CORP., 1968), and JP Patent Publication (Unexamined Application) No. 60-22770. Among hydrophilic or water soluble cellulose derivatives, it is preferred to use a water soluble cellulose ether in which a part or substantially all of a hydroxyl group has been etherified with a lower alkyl group having 1 to 3 carbon atoms or a hydroxyl-substituted lower alkyl group having 1 to 4 carbon atoms. A water soluble cellulose ether used herein can generally have a molecular weight of about 8,000 to about 1,000,000, and preferably about 10,000 to about 300,000. Examples of a cellulose ether include methyl cellulose, ethyl cellulose, hydroxyethyl cellulose, hydroxypropylmethyl cellulose, and hydroxybutylmethyl cellulose. Among them, methyl cellulose and hydroxypropylmethyl cellulose are preferable.

As a hydrophilic vinyl polymer or copolymer; a wide range of hydrophilic or water soluble vinyl polymers described in, for example, the literature mentioned above, JP Patent Publication (Unexamined Application) No. 59-171864, and JP Patent Publication (Unexamined Application) No. 60-115859 can be used. Among them polyvinyl alcohol, polyvinyl ether, polyvinyl pyrrolidone, and the like are preferable.

Examples of a hydrophilic acrylic acid derivative polymer or copolymer include polyacrylic acid, β-hydroxypropyl acrylate, and polyacrylamide.

Preferably, a hydrophilic polymer is soluble in organic solvents such as methanol, ethanol, β-methoxyethanol, dioxane, and ethylene glycol.

The coating amount of the hydrophilic polymer is in the range of about 0.1 g/m² to about 30 g/m², and preferably about 0.5 g/m² to about 20 g/m².

The hydrophilic polymer cal be used in combination with a small amount of hydrophobic polymer. A hydrophobic polymer that can be used includes a polymer which is compatible with and substantially uniformly mixed with a hydrophilic polymer, and contrastingly, a polymer which is poor in compatibility and causes phase separation. The hydrophobic polymer can be used in the range of about 40% or less, and preferably about 33% or less by weight, based on the hydrophilic polymer.

Examples of the hydrophobic polymer that can be mixed with a hydrophilic polymer include a hydrophobic cellulose derivative polymer, a hydrophobic vinyl polymer or copolymer, and a hydrophobic acrylic acid derivative polymer or copolymer.

Examples of the hydrophobic cellulose derivative polymer include hydrophobic cellulose ether and cellulose ester. Examples of cellulose ether include methyl cellulose and ethyl cellulose. Examples of cellulose ester include acetyl cellulose.

Examples of the hydrophobic vinyl polymer include polyvinyl acetate and polyvinyl methyl ether.

Examples of the hydrophobic acrylic acid derivative polymer include an acrylate ester polymer and a methacrylate ester polymer. The acrylate ester polymer includes polymethyl acrylate, polyethyl acrylate, and polybutyl acrylate. The methacrylate ester polymer includes a lauryl methacrylate copolymer.

The water-absorbing layer, the reagent layer and the developing layer can contain, in addition to an indicator, an organic acid or an acidic pH buffer containing organic acid (hereinafter they nay be referred to as a buffer) which can maintain the pH value in the region where an aqueous liquid sample (e.g., biological body fluids such as whole blood, blood plasma, serum, lymph, spinal fluid, or urine) was spotted and spread during the analyzing operation in the range of about 2.0 to about 4.0, and preferably in the range of about 2.5 to about 3.5. The organic acid used is at least one member selected from the group consisting of hydroxycarboxylic acid and dicarboxylic acid. Examples of hydroxycarboxylic acid include malic acid, lactic acid, succinic acid, malonic acid, citric acid, and tartaric acid described in, for example, JP Patent Publication (Unexamined Application) No. 57-50660, JP Patent Publication (Unexamined Application) No. 61-243364, and JP Patent Publication (Unexamined Application) No. 62-27664. Examples of dicarboxylic acid include malonic acid, succinic acid, glutaric acid, adipic acid, pimelic acid, and 3,3-dimethylglutaric acid. Among them, malic acid is preferable. In addition to the above-mentioned organic acids, other pH buffer compositions described in, for example, “Kagaku Binran. Kiso-Hen (Chemical Handbook, Fundamental Volume)” (the Chemical Society of Japan (ed.), MARUZEN, Toko, 1966, p. 1312-1320) and U.S. Pat. No. 3,438,737 can also be used. The content of the buffer in the water-absorbing layer, reagent layer or developing layer is about 30 milliequivalent to about 500 milliequivalent per m², and preferably about 50 milliequivalent to about 300 milliequivalent per m². The content of the malic acid is about 0.5 to 35 g per m², and preferably about 0.5 to 20 g per m². Preferably, the buffer is dispersed in a hydrophilic polymer together with the reagent, and held in the water-absorbing layer, reagent layer and/or developing layer in a dispersed state.

Methods for incorporating hydrophilic polymers retaining an indicator and a buffer in a dispersed state into the reagent layer or the developing layer include: a method for substantially uniformly coating or spraying, an aqueous solution, a mixed solution of water and organic solvent or a solution of organic solvent (examples of organic solvents: aliphatic alcohols such as methanol, ethanol and isopropyl alcohol; dialkyl ketone such as acetone and methyl ethyl ketone; dialkyl ether such as dimethyl ether; alicyclic ether such as tetrahydrofuran and dioxane; acetonitrile; hexane; β-methoxy ethanol; and ethylene glycol) which contains an indicator and a polymer, on the developing layer and drying the coating in accordance with conventional methods; and a method where a material for the developing layer is immersed in a solution containing an indicator, a buffer, and a hydrophilic polyp, and is laminated on the water-absorbing layer (a hydrophilic polymer binder layer) in a dried or semi-dried state to prepare a single unit. When a solution containing an indicator, a buffer and a hydrophilic polymer is coated or sprayed on the developing layer, preferably, a solvent for dissolving these three components can be suitably selected from among those capable of dissolving or dispersing them without dissolving the hydrophilic polymer layer of the water-absorbing layer.

A surfactant can also be contained together with an indicator, a buffer and a hydrophilic polymer, to uniformly retain an indicator and a polymer in the developing layer, thereby controlling the release speed of the indicator when an aqueous liquid sample is spotted. An aqueous liquid sample can be uniformly developed. Any of an anionic, cationic, nonionic or ampholytic surfactant can be used as a surfactant, with a nonionic surfactant being preferred. Specific examples of a nonionic surfactant include p-octylphenoxy polyethoxyethanol p-nonylphenoxypolyethoxyethanol, polyoxyethylene oleyl ether, polyoxyethylene sorbitan monolaurate, p-nonylphenoxypolyglycidol, and octyl glucoside. Among them, polyoxyethylene oleyl ether is preferable. A content of the nonionic surfactant in die developing layer is in the range of about 20 mg to about 10 g per m², and preferably about 30 mg to about 5.0 g per m².

The dry analytical element according to the present invention can be prepared by known methods described in the specifications of the above-mentioned patents.

From the viewpoint of production, packaging, transportation, storage, measurement operation and the like, the dry analytical element according to the present invention is preferably used as a slide for chemical analysis by cutting the element into squares having a side length of about 15 mm to about 30 mm or pieces of the same shape having substantially the same size and accommodating them in the slide frames described in, for example, JP Patent Publication (Unexamined Application) No. 57-28331, JP Utility Model Publication (Unexamined Application) No. 56-142454, JP Patent Publication (Unexamined Application) No. 57-63452, JP Utility Model Publication (Unexamined Application) No. 58-32350, and JP Patent Publication (PCT Translation) No. 58-501144. In some applications, the element can be used in a long tape form by being accommodated in a cassette or magazine or applying or accommodating small pieces in a card having openings.

The multilayer analytical element according to the present invention enables the quantitative analysis of the analyte (e.g., albumin) in the liquid sample by operations described in various patent descriptions mentioned above. For example, about 5 μL to about 30 μL, preferably about 8 μL to about 15 μl, of aqueous liquid sample such as whole blood, blood plasma, serum, lymph, and urine is spotted on the developing layer, the sample is incubated at a substantially constant temperature, i.e., about 20° C. to about 40° C., and preferably at around 37° C., for about 1 minute to about 10 minutes, and preferably about 2 minutes to about 7 minutes, and subjected to reflection photometry from the light-transmissive support side for a detectable change such as color change and color development in the dry analytical element to determine the content of the component to be analyzed in the liquid sample based on the principle of colorimetry. For example, when albumin is analyzed light having the wavelength of maximal absorption of the albumin-acid-base indicator dye bond or a wavelength of the vicinity thereof is used to conduct reflection photometry of the optical density of the reagent-developing layer to determine the albumin content in the liquid sample by using a previously prepared calibration curve based on the principle of colorimetry. Quantitative analysis of the analyte can be performed with high accuracy by keeping the amount of an aqueous liquid sample to be spotted and the time and the temperature for incubation at constant levels. The quantitative analysis can be performed with high accuracy in a very simple operation by using the chemical analyzer described in, for example, JP Patent Publication (Unexamined Application) No. 60-125543, JP Patent Publication (Unexamined Application) No. 60-220862, JP Patent Publication (Unexamined Application) No. 61-294367, and JP Patent Publication (Unexamined Application) No. 58-161867.

The present invention will be described in more detail with reference to the following examples. The following examples is provided for the purpose of illustrating the present invention, and do not limit the scope of the present invention.

### EXAMPLES

### Example 1

An aqueous solution having the following composition was coated on a colorless transparent smooth polyethylene terephthalate film (180 μm) undercoated with gelatin, to a thickness of 40 μm on a dry basis, and the coating was dried.

| (Layer Q) | |
|---|---|
| Polymer Aam-VP-MAOH | 40.0 g/m² |
| Malic acid | 5.0 g/m² |
| Surfactant | 1.0 g/m² |

“Polymer Aam-VP-MAOH” refers to a ternary copolymer of polyacrylamide-N-vinyl-2-pyrrolidone-methallyl alcohol (monomer molar ratio of 57:38:5, Fuji Photo Film Co. Ltd.).

Polyoxy (2-hydroxy)propylene nonylphenyl ether (Surfactant 10G Olin Corporation) was used as a surfactant.

Subsequently, water was supplied on the whole area of the above-mentioned film in an amount of about 30 g/m² to wet the film. Thereafter, a tricot knitted fabric, which was prepared by knitting polyethylene terephthalate yarns (50 deniers equivalent) at 36 gauges, was laminated thereon by applying a light pressure, and the laminate was then dried.

An ethanol solution having the following composition (OC1) was then coated to a thickness of 5 μm on a dry base with each of the components being in amounts specified below, and the coating was then dried. An ammonium sulfate-containing aqueous solution (OC2) was further coated and dried to prepare a single-unit multilayer analytical element.

| (OC1) | |
|---|---|
| Ethanol | 6.2 g/m² |
| BCG | 1.0 g/m² |
| Malic acid | 1.0 g/m² |
| Polyvinyl pyrrolidone | 5.0 g/m² |
| Surfactant | 0.5 g/m² |

Polyoxyethylene oleyl ether (B30-7, Nihon Chemicals) was used as the surfactant.

| (OC2) | |
|---|---|
| Purified water | 30.0 g/m² |
| Ethanol | 25.0 g/m² |
| Ammonium sulfate | 3.0 g/m² |
| Malic acid | 5.0 g/m² |
| Polyvinyl pyrrolidone | 1.0 g/m² |
| Surfactant | 0.1 g/m² |

The single-unit multilayer analytical element was cut into 12 mm×13 mm-chips and accommodated in a slide frame (described in JP Patent Publication (Unexamined Application) No. 57-63452) to prepare a dry slide (1) for analyzing albumin according to the present invention.

### Comparative Example 1

A comparative dry slide (2) for analyzing albumin was prepared in the same manner as in Example 1, except that ammonium sulfate was not contained in OC2.

### Measurement Example 1

10 μL of a sample which was prepared to have a globulin concentration of 2.5 or 7 g/dL was spotted onto the dry slides (1) and (2) for analyzing albumin prepared in Example 1 and Comparative Example 1. The area where the sample was developed was Yeast. The results are shown in Table 1 below. The unit of the values in Table 1 is cm².

As is apparent from the results in Table 1, when the dry slide (1) for analyzing albumin of the present invention was used, variation of the developing area was smaller even if the globulin concentration increased, as compared with the case when the dry slide (2) for analyzing albumin of Comparative Example was used.

TABLE 1

| Globulin | Slide (1) | Slide (2) |
|---|---|---|
| concentration | (The present invention) | (Comparative Example) |
| 2.5 g/dL | 0.79 | 0.89 |
| 7 g/dL | 0.78 | 0.80 |

### Measurement Example 2

10 μL of blood sera to which globulin was added to the globulin concentration of 3, 5, or 9 g/dL, were spotted on the dry slides (1) and (2) for analyzing albumin prepared in Example 1 and Comparative Example 1 above. Then, while incubating at 37° C. for 5 minutes, the reflection density at 625 nm was measured using Fuji Dry-Chem 5000 (Fuji Photo Film Co., Ltd.) every about 10 seconds. The reflection density for the 5 minutes was determined. The results are shown in Table 2 below. The unit of the values in Table 2 is the reflective optical density.

As is apparent firm the results in Table 2, when the dry slide (1) for analyzing albumin according to the present invention was used, variation of the measured albumin values caused by the globulin concentration was smaller as compared with the case when the dry slide (2) for analyzing albumin of Comparative Example was used.

TABLE 2

| | Slide (1) | Slide (2) |
|---|---|---|
| | (The present invention) | (Comparative Example) |
| Human serum | 0.920 | 0.782 |
| Human serum + globulin (3 g/dL) | 0.919 | 0.785 |
| Human serum + globulin (5 g/dL) | 0.921 | 0.803 |
| Human serum + globulin (9 g/dL) | 0.921 | 0.934 |

### EFFECT OF THE INVENTION

According to the techniques of the present invention, variation of the developing area due to the existence of globulin can be inhibited by precipitating globulin in the sample on a fabric. Also, the albumin values can be accurately measured by inhibiting the binding between globulin and a reagent which changes color upon reaction with albumin. Further, according to the present invention, the speed of transportation of the sample below the fabric is increased and sensitivity is improved.

Specifically, the present invention can provide a dry analytical element which can overcome the drawback that the viscosity of a sample varies depending on the globulin concentration and the developing area of the sample varies, and can also avoid an error caused by the reaction between the reagent which changes color upon reaction with albumin, and globulin in the sample.

The present invention claims a priority based on JP Patent Application No. 2002-030401, the entire content of which is incorporated herein by reference.

1. A dry analytical element comprising, on a supports a layer containing a reagent capable of precipitating globulin.

2. The dry analytical element according to claim 1, wherein the reagent capable of precipitating globulin is sodium sulfate, sodium sulfite, or ammonium sulfate.

3. The dry analytical element according to claim 1 which is used to detect albumin.

4. The dry analytical element according to claim 2 which is used to detect albumin.

5. The dry analytical element according to claim 3 comprising, on a support, a layer containing a reagent which changes color upon binding with albumin and a layer containing a reagent capable of precipitating globulin.

6. The dry analytical element according to claim 4 comprising, on a support, a layer containing a reagent which changes color upon binding with albumin and a layer containing a reagent capable of precipitating globulin.

7. The dry analytical element according to claim 5 comprising at least a layer containing a reagent which changes color upon reaction with albumin and a layer containing a reagent capable of precipitating globulin, both layers of which are integrally laminated in that order on a light-transmissive water-impermeable support.

8. The dry analytical element according to claim 6 comprising at least a layer containing a reagent which changes color upon reaction with albumin and a layer containing a reagent capable of precipitating globulin, both layers of which are integrally laminated in that order on a light-transmissive water-impermeable support.
